(19) United States
(12) Patent Application Publication
(10) Pub. No.: US 2018/0156165 A1
(43) Pub. Date: Jun. 7, 2018

(54) CHARGE AIR COOLER WITH AN INTEGRATED BYPASS

(71) Applicant: Ford Global Technologies, LLC, Dearborn, MI (US)

(72) Inventors: Meisam MEHRAVARAN, Royal Oak, MI (US); Joshua Putman STYRON, Canton, MI (US)

(21) Appl. No.: 15/371,374

(22) Filed: Dec. 7, 2016

(51) Int. Cl. F02M 31/20; F02B 29/04; F02D 41/00; F02D 41/14; F28F 13/12; F28F 27/02

(52) U.S. Cl. CPC F02M 31/205; F02B 29/0418; F02B 29/0475; F02D 41/0007; F02D 41/1444; F28F 2250/06; F28F 13/12; F28F 27/02; F02D 2200/0418; F02D 2200/0414; F02B 29/0493

(57) ABSTRACT

A charge air cooler may include inlet and outlet chambers adjacent one another and separated by a baffle defining a bypass passage for airflow therethrough. The charge air cooler may also include heat exchange conduits connected between the inlet and outlet chambers. A valve may be disposed in the bypass passage and configured to selectively redirect at least a portion of the airflow through the bypass passage responsive to a charge air cooler outlet temperature being below a condensation temperature of the airflow.

### TECHNICAL FIELD

This disclosure relates generally to a charge air cooler having an integrated bypass in a motor vehicle.

### BACKGROUND

Turbocharged and supercharged engines may be configured to compress ambient air entering the engine to increase power. Because compressing the air may cause an increase in temperature of the air, a charge air cooler may be utilized to cool the heated air, increasing its density and further increasing the potential power of the engine. If the humidity of the ambient air is high, condensation may form on any internal surface of the charge air cooler that is colder than the dew point of the compressed air. During operating conditions such as high vehicle acceleration, for example, these water droplets may be blown out of the charge air cooler and into the combustion chambers of the engine. This may result in engine misfire, loss of torque and engine speed, and incompletely burned fuel, for example.

### SUMMARY

In one embodiment, a charge air cooler includes inlet and outlet chambers adjacent one another and separated by a baffle defining a bypass passage for airflow therethrough. The cooler includes heat exchange conduits connected between the inlet and outlet chambers. A valve is disposed in the bypass passage and configured to selectively redirect at least a portion of the airflow therethrough responsive to a charge air cooler outlet temperature being below a condensation temperature of the airflow. The condensation temperature may be a dew point of the airflow determined from ambient air temperature and relative humidity. The valve includes a valve flap movable to open and close the bypass passage. The valve flap has a turbulence-generating element arranged on an exterior surface thereof that is adapted to generate turbulence within the airflow in the charge air cooler.

In another embodiment, a charge air cooler includes an inlet chamber adjacent an outlet chamber, heat exchange conduits connected between the inlet and outlet chambers, and a bypass fluidly connecting the inlet chamber to the outlet chamber. A flow control device may be positioned in the bypass and configured to control airflow from the inlet chamber to the outlet chamber through the bypass to maintain a charge air cooler outlet temperature above a condensation temperature of the airflow. The flow control device may be further configured to close the bypass responsive to a temperature difference between the inlet chamber and the outlet chamber being below a threshold. And, the flow control device may be configured to open the bypass responsive to the temperature difference between the inlet chamber and the outlet chamber exceeding the threshold. The flow control device may be one of a solenoid valve, a stepper motor valve and a magnetically actuated valve.

In yet another embodiment, a method for controlling airflow within a charge air cooler having a bypass fluidly connecting an inlet chamber to an outlet chamber may include commanding a valve disposed within the bypass to open and redirect at least a portion of the airflow through the bypass in response to a charge air cooler outlet temperature being below a condensation temperature of the airflow. The method may further include commanding the valve to close the bypass in response to the charge air cooler outlet temperature exceeding the condensation temperature of the airflow. The method may include commanding the valve to open the bypass in response to a temperature differential between the inlet and outlet chambers exceeding a corresponding threshold. The valve may be a proportional valve that adjusts a flow rate of air through the bypass based on the charge air cooler outlet temperature relative the condensation temperature of the airflow

Embodiments according to the present disclosure provide a number of advantages. For example, the present disclosure provides a method for reducing the formation of condensation on the internal surfaces of a charge air cooler by bypassing airflow within the cooler to maintain air temperature at the cooler outlet above the condensation temperature of the charge air (e.g., dew point at which condensation may occur). The above advantages and other advantages and features of the present disclosure will be readily apparent from the following detailed description of the preferred embodiments when taken in connection with the accompanying drawings.

### BRIEF DESCRIPTION OF THE DRAWINGS

FIG. 1 is a schematic diagram of an engine including a charge air cooler according to embodiments of the present disclosure;

FIG. 2 is a schematic representation of a charge air cooler according to embodiments of the present disclosure;

FIG. 3A is a top plan view of a charge air cooler valve flap having turbulence-generating elements according to embodiments of the present disclosure;

FIG. 3B is a front elevation view of the charge air cooler valve flap of FIG. 3A in accordance with embodiments of the present disclosure;

FIG. 4A is a top plan view of another charge air cooler valve flap having turbulence-generating elements according to embodiments of the present disclosure;

FIG. 4B is a front elevation view of the charge air cooler valve flap of FIG. 4A in accordance with embodiments of the present disclosure;

FIG. 5 is a flow chart illustrating a method for adjusting a position of a charge air cooler valve based on a charge air cooler outlet temperature according to embodiments of the present disclosure; and

FIG. 6 is a flow chart illustrating a method for adjusting a position of a charge air cooler valve based on a temperature differential between inlet and outlet chambers of the charge air cooler in accordance with embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated and/or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Condensation formation in a charge air cooler (CAC) may be detrimental to the engine, as the introduction of the condensate to the cylinders during combustion may cause combustion instability and/or misfire. Moreover, condensation formation may degrade the charge air cooler, particularly, if accumulated condensate freezes during an extended engine off period. To reduce the accumulation of condensation, a flow control device, such as a valve, may be positioned in a bypass passage connecting inlet and outlet chambers of the charge air cooler and may be configured to selectively route the charge air directly from an inlet chamber to an outlet chamber of the cooler via the bypass passage thereby allowing a portion of the charge air to bypass the heat exchange portion (or cooler core) of the charge air cooler. The process of bypassing charge air directly from the inlet chamber to the outlet chamber of the cooler increases the cooler outlet temperature above the temperature at which condensate forms (i.e., dew point) to reduce and/or avoid condensation formation within the cooler. The valve may be configured to open or close in response to a CAC outlet temperature being above or below a dew point of the charge air, which is the temperature that condensation is likely to form within the cooler. The dew point (i.e., condensation temperature) of the charge air may be determined from ambient air temperature and relative humidity. Further, the valve may include a valve flap or plate having turbulators (i.e., turbulence-generating elements) arranged on a surface thereof to generate turbulence within the airflow in the cooler to further reduce and/or minimize condensate formation.

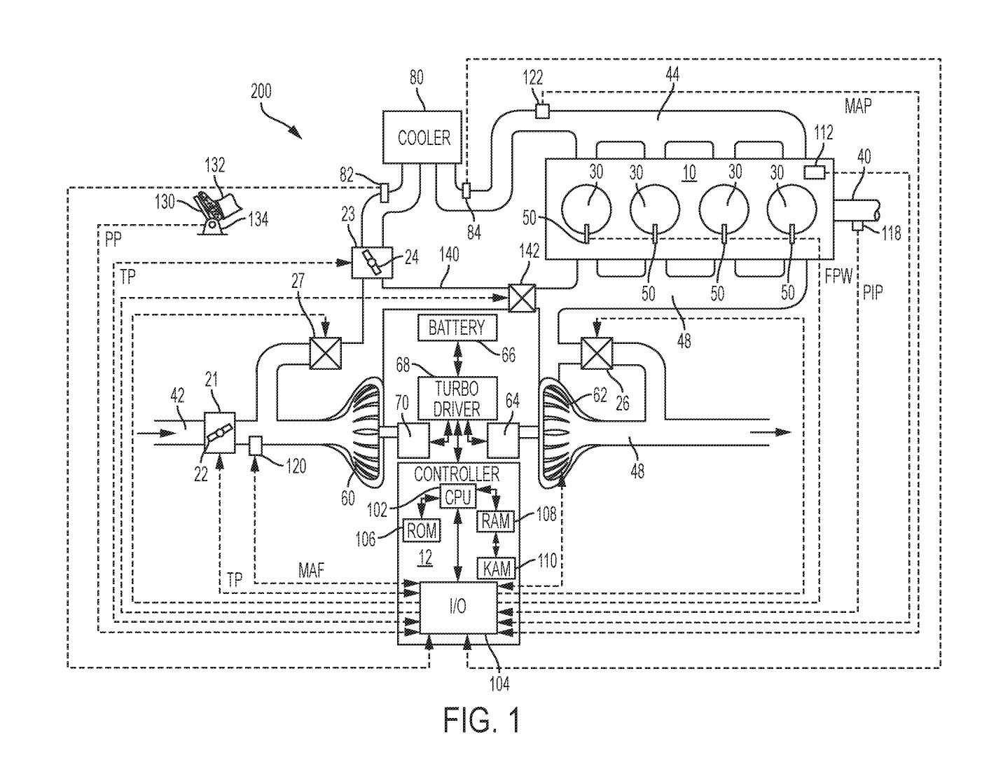

Referring now to FIG. 1, a schematic diagram of an engine system including an engine 10 and a charge air cooler 80 is illustrated, which may be included in a propulsion system of a motor vehicle. Engine 10 is shown with four cylinders 30; however, other numbers of cylinders may be used in accordance with the present disclosure. Engine 10 may be controlled at least partially by a control system including controller 12, and by input from a vehicle operator 132 via an input device 130. In this example, input device 130 includes an accelerator pedal and a pedal position sensor 134 for generating a proportional pedal position signal PP. Each combustion chamber (e.g., cylinder) 30 of engine 10 may include combustion chamber walls with a piston (not shown) positioned therein. The pistons may be coupled to a crankshaft 40 so that reciprocating motion of the piston is translated into rotational motion of the crankshaft. Crankshaft 40 may be coupled to at least one drive wheel of a vehicle via an intermediate transmission system (not shown). Further, a starter motor may be coupled to crankshaft 40 via a flywheel to enable a starting operation of engine 10.

Combustion chambers 30 may receive intake air from intake manifold 44 via intake passage 42 and may exhaust combustion gases via exhaust passage 48. Intake manifold 44 and exhaust manifold 48 can selectively communicate with combustion chambers 30 via respective intake valves and exhaust valves (not shown). In some embodiments, combustion chambers 30 may include two or more intake valves and/or two or more exhaust valves. Fuel injectors 50 are shown coupled directly to combustion chambers 30 for injecting fuel directly therein in response to a signal received from controller 12. The fuel injectors may be mounted in the side of the combustion chambers 30 or in the top of the combustion chamber 30, for example. Fuel may be delivered to fuel injectors 50 by a fuel system (not shown) including a fuel tank, a fuel pump, and a fuel rail. In some embodiments, combustion chambers 30 may alternatively, or additionally, include fuel injectors 50 arranged in a configuration that provides what is known as port injection of fuel into the intake port upstream from combustion chambers 30.

Intake passage 42 may include throttles 21 and 23 having throttle plates 22 and 24, respectively. In this particular example, the position of throttle plates 22 and 24 may be varied by controller 12 via signals provided to an electric motor or actuator included with throttles 21 and 23, a configuration that is commonly referred to as electronic throttle control (ETC). In this manner, throttles 21 and 23 may be operated to vary the intake air provided to combustion chambers 30 among other engine cylinders. The position of throttle plates 22 and 24 may be provided to controller 12 by throttle position signal TP. Intake passage 42 may further include a mass air flow sensor 120 and a manifold air pressure sensor 122 for providing respective signals MAF and MAP to controller 12.

Controller 12 is shown in FIG. 1 as a microcomputer, including microprocessor unit 102, input/output ports 104, an electronic storage medium for executable programs and calibration values shown as read only memory (ROM) 106 in this particular example, random access memory (RAM) 108, keep alive memory (KAM) 110, and a data bus. Controller 12 may receive various signals from sensors coupled to engine 10, in addition to those signals previously discussed, including measurement of inducted mass air flow (MAF) from mass air flow sensor 120; charge air cooler inlet temperature from temperature sensor 82; charge air cooler outlet temperature from temperature sensor 84; engine coolant temperature (ECT) from temperature sensor 112, shown schematically in one location within the engine 10; a profile ignition pickup signal (PIP) from Hall effect sensor 118 (or other type) coupled to crankshaft 40; the throttle position (TP) from throttle position sensors 21, 23; and absolute manifold pressure signal (MAP) from sensor 122.

An exhaust gas recirculation (EGR) system may route a desired portion of exhaust gas from exhaust passage 48 to intake passage 42 via EGR passage 140. The amount of EGR provided to intake passage 42 may be varied by controller 12 via EGR valve 142. Further, an EGR sensor (not shown) may be arranged within the EGR passage and may provide an indication of one or more of pressure, temperature, and concentration of the exhaust gas.

Engine 10 may further include a compression device such as a turbocharger or supercharger including at least a compressor 60 arranged along intake manifold 44. For a turbocharger, compressor 60 may be at least partially driven by a turbine 62, via, for example a shaft, or other coupling arrangement. The turbine 62 may be arranged along exhaust passage 48. Various arrangements may be provided to drive the compressor 60. For a supercharger, compressor 60 may be at least partially driven by the engine 10 and/or an electric machine, and may not include a turbine. Thus, the amount of compression provided to one or more cylinders of the engine 10 via a turbocharger or supercharger may be varied by controller 12. In some cases, the turbine 62 may be coupled to an electric generator 64, to provide power to a battery 66 via a turbo driver 68. Power from the battery 66 may then be used to drive the compressor 60 via a motor 70. Exhaust passage 48 may include wastegate 26 for diverting exhaust gas away from turbine 62. Additionally, intake passage 42 may include a wastegate 27 configured to divert intake air around compressor 60. Wastegates 26, 27 may be controlled by controller 12 to be opened when a lower boost pressure is desired, for example.

Intake passage 42 may further include charge air cooler (CAC) 80 to decrease the temperature of the turbocharged or supercharged intake gases. In some embodiments, charge air cooler 80 may be an air to air heat exchanger. In other embodiments, charge air cooler 80 may be an air to liquid heat exchanger. If the humidity of the ambient air is high, condensation may form on any internal surface of the charge air cooler 80 that is colder than the dew point of the compressed air. During conditions such as high vehicle acceleration, these water droplets may be blown out of the charge air cooler 80 and into the combustion chambers of the engine 10 resulting in engine misfire, loss of torque and engine speed, and incompletely burned fuel, for example.

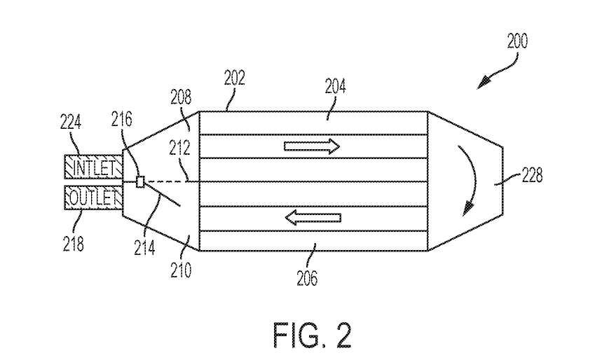

A charge air cooler according to the present disclosure, and operation of the same, will be described in conjunction with FIGS. 2-6. Referring now to FIG. 2, a charge air cooler 200 having an integrated bypass valve 214 is shown. Charge air cooler 200 may be incorporated into a turbocharger or supercharger system such as that illustrated in FIG. 1. Charge air cooler 200 includes an inlet chamber 208 having inlet 224, an outlet chamber 210 having outlet 218, and a cooler core 202 having a first flow path 204 and a second flow path 206 that run parallel and adjacent to one another within the cooler core 202. The flow paths 204, 206 include a plurality of flow ducts for cooling the charge air, which are formed in the present case as flat tubes of rectangular cross section. However, the cross section may also have some other shape, for example the cross section could be circular.

Inlet chamber 208 and outlet chamber 210 are arranged at a first side of cooler core 202. The inlet and outlet chambers 208, 210 are adjacent to one another and separated by a baffle 212. Inlet chamber 208 directs intake gases (i.e., charge air) from inlet 224 into cooler core 202, within which heat exchange takes place to cool the intake gases. In particular, inlet chamber 208 directs intake gases from inlet 224 into a first flow path 204, wherein the intake gases are initially subjected to a first cooling. After flowing through the first flow path 204, the intake gases are directed into a deflecting region 228, which is arranged on a second side of the cooler core 202. The intake gases are then redirected into the second flow path 206 to be subjected to a second cooling. The cooled intake gases are then directed through outlet chamber 210, exiting outlet 218, and into a passage (not shown) connecting to an engine intake manifold.

Baffle 212 may include an opening or a bypass passage arranged so that the inlet chamber 208 is in direct fluid communication with the outlet chamber 210. A flow control device 214, such as a valve, may be disposed within the bypass passage and coupled thereto for selectively bypassing at least a portion of the intake gases directly from inlet chamber 208 to outlet chamber 210 under certain operating conditions to reduce condensation formation within the cooler 200 and reduce high thermal stresses resulting from large temperature differentials between inlet and outlet chambers 208, 210. Valve 214 may be coupled to actuator 216 and configured to open in response to a CAC outlet temperature being below a condensation temperature (e.g., dew point) of the charge air. The condensation temperature or dew point may be determined from ambient air temperature and relative humidity. Opening valve 214 and bypassing intake gases therethrough in response to a CAC outlet temperature being below the dew point of the intake gases reduces condensation formation by raising the temperature within the outlet chamber 210. Likewise, in response to the CAC outlet temperature being above the dew point, valve 214 is configured to close to inhibit flow of intake gases therethrough. Valve 214 may also be configured to open in response to a temperature difference between inlet and outlet tanks 208, 210 exceeding a corresponding threshold to reduce thermal stresses. Actuator 216 may be a stepper motor, a solenoidal actuator with pulse width modulation (PWM), or a magnetically controlled actuator for opening and closing valve 214. Valve 214 may be proportionally opened using actuator 216 (i.e., a proportional valve).

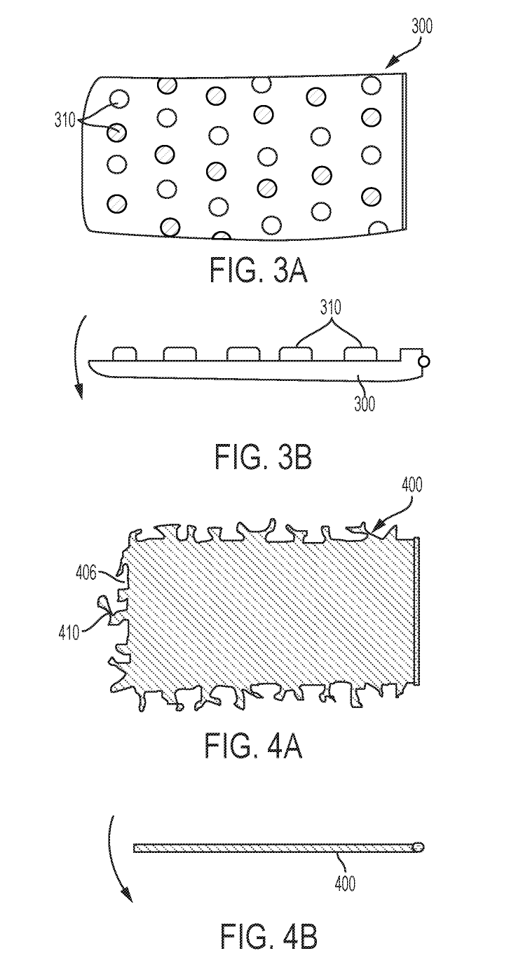

Although opening valve 214 to bypass a portion of the airflow degrades the heat transfer within cooler 200 and increases the CAC outlet temperature to reduce condensation formation, some of the airflow that goes through cooler core 202 may still form condensate on internal surfaces of the cooler 200. To address this, turbulators or turbulence-generating elements, such as ribs, protrusions, dimples, etc., may be arranged on a valve flap or plate of valve 214 to create turbulence within cooler 200. Turbulent airflow, in comparison to laminar airflow, is known to improve evaporation and reduce condensate within a charge air cooler 200. With reference to FIGS. 3-4, valve 214 may include a valve flap having turbulators or turbulence-generating elements of various configurations to create turbulence within the airflow in the cooler to reduce condensate formation.

As shown in FIGS. 3A and 3B, valve flap 300 may include turbulators (or turbulence-generating elements) 310 arranged on a surface thereof. Turbulators 310 are adapted to create turbulent airflow within the cooler to reduce condensate. Turbulators 310 may include, but is not limited to, ribs, dimples and protrusions of varying shape and size, for example. Similarly, FIGS. 4A and 4B illustrate a valve flap 400 including turbulators 406, 410 in the form of recesses 406 and protrusions 410 along a periphery of the valve flap 400. Such recesses 406 and protrusions 410 create turbulent airflow within the cooler for condensation reduction and elimination. One of ordinary skill in the relevant art would understand that other types of elements could be used to function as a turbulator to create turbulence within the airflow.

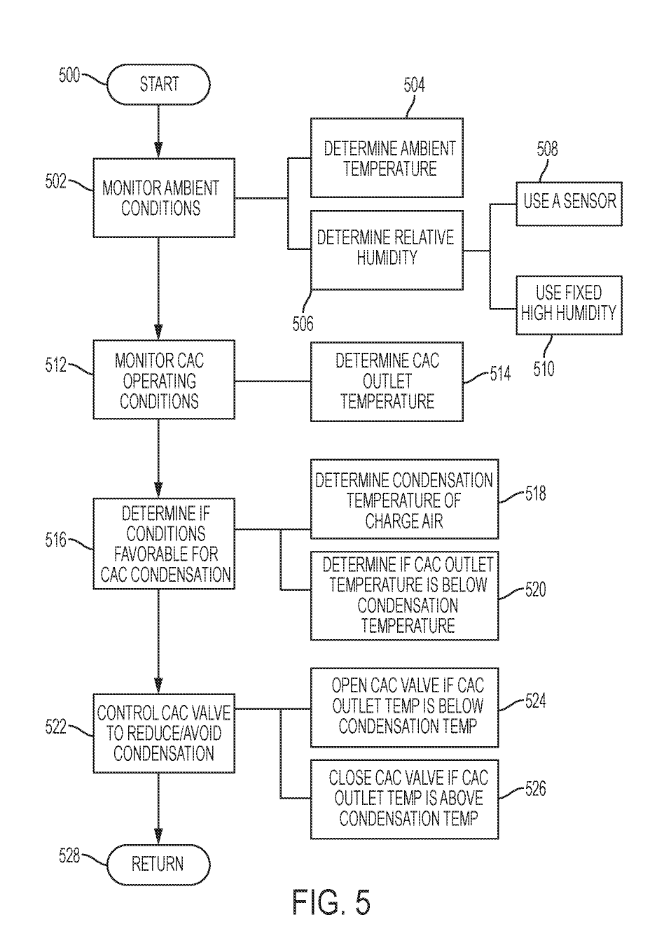

Referring to FIG. 5, a method is provided for controlling a CAC bypass valve based on a CAC outlet temperature as compared to a condensation temperature of charge air. The condensation temperature of the charge air may be the dew point of the charge air determined from ambient air temperature and relative humidity using known methods and techniques. The method begins at step 500 and current ambient conditions are monitored and determined at step 502. Ambient conditions may be determined using appropriate sensors, estimated or inferred depending on the particular application. Preferably, step 502 includes at least a determination of the ambient air temperature at step 504 and a determination of relative humidity at step 506. The relative humidity at step 506 may be determined using a sensor as shown at step 508 or it may be set to a predetermined value as shown at step 510. For example, rather than requiring a humidity sensor, the present disclosure may use a fixed high value for relative humidity, such as 100%, which represents a conservative calibration.

At step 512, current CAC operating conditions are monitored and determined. Preferably, step 512 includes at least a determination of CAC outlet temperature as shown at step 514. The current ambient and CAC operating conditions determined in steps 502 and 512, respectively, are then used to determine whether conditions are favorable for CAC condensation formation as shown at step 516. In particular, a condensation temperature of the charge air within the CAC is determined based on current ambient conditions as shown at step 518. The condensation temperature may be the dew point of the charge air, which may be determined from the ambient temperature and relative humidity determined in steps 504 and 506. The condensation temperature as determined at step 518 is then compared at step 520 with the CAC outlet temperature determined previously at step 514. It is determined at step 520 whether the CAC outlet temperature is below the condensation temperature, which would indicate conditions favorable to CAC condensation formation. The CAC bypass valve is then controlled to reduce and/or avoid condensation formation within the CAC at step 522. In particular, the CAC bypass valve may be controlled and/or commanded to open if conditions are favorable for condensation formation (i.e., CAC outlet temperature is below the condensation temperature), as shown at step 524. Preferably, through opening CAC bypass valve, some or all of the charge air may be redirected to flow directly from the inlet chamber to the outlet chamber of the CAC while bypassing the cooler core to raise the CAC outlet temperature. Alternately, the CAC bypass valve may be controlled and/or commanded to close if the CAC outlet temperature is above the condensation temperature and conditions aren't favorable for condensation formation, as shown at step 526. The method then ends at step 528.

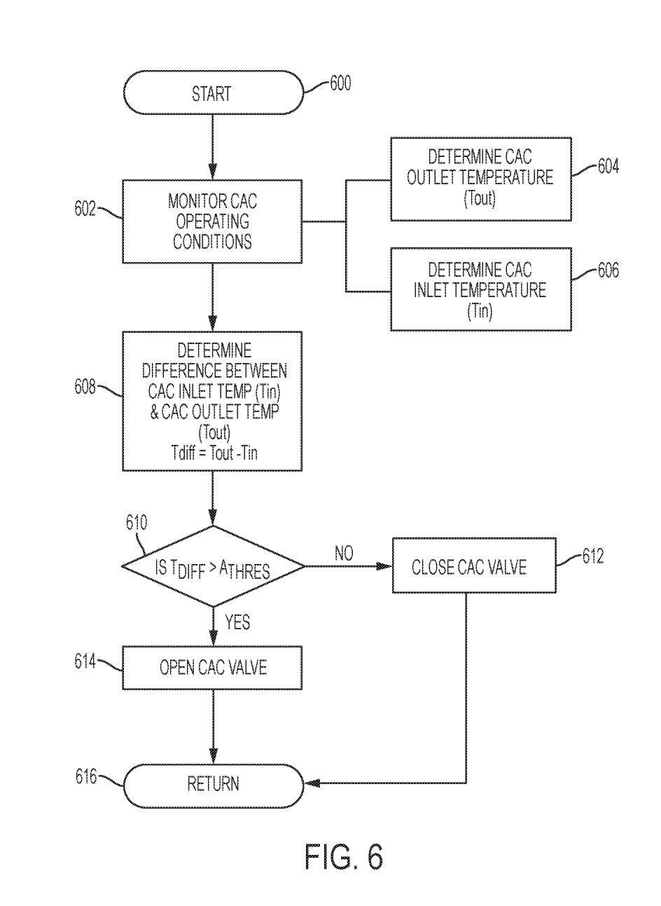

Referring to FIG. 6, a method is provided for controlling a charge air cooler bypass valve based on a temperature differential between inlet and outlet chambers to reduce thermal stresses therein. The method begins at step 600 and current CAC operating conditions are determined at step 602. Preferably, step 602 includes at least a determination of CAC outlet temperature (Tₒᵤₜ) as shown at step 604 and a determination of CAC inlet temperature (Tᵢₙ) as shown at step 606. The difference (T_{diff}) between the CAC outlet temperature (Tₒᵤₜ) and the CAC inlet temperature (Tᵢₙ) is determined at step 608. At step 610, it is then determined whether the temperature difference (T_{diff}) between the CAC outlet and inlet is greater than a predetermined threshold (Aₜₕᵣₑₛ). The predetermined threshold may be based on CAC thermal stress tolerances. If the temperature difference (T_{diff}) between the CAC outlet and inlet is less than the predetermined threshold (Aₜₕᵣₑₛ), then the CAC bypass valve is closed at step 612 and the method ends at step 616. If the temperature difference (T_{diff}) between the CAC outlet and inlet is greater than a predetermined threshold (Aₜₕᵣₑₛ), then the CAC valve is opened to lower the temperature differential between the CAC inlet and outlet at step 614. The method then ends at step 616.

As can be seen by the representative embodiments described herein, embodiments according to the present disclosure provide robust strategies for reducing the formation of condensation on the internal surfaces of a CAC by using an internal bypass valve or flow control device to selectively redirect airflow within the cooler to maintain air temperature at the CAC outlet above a condensation temperature of the charge air.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure. While the best mode has been described in detail, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments discussed herein that are described as less desirable than other embodiments or prior art implementations with respect to one or more characteristics are not outside the scope of the disclosure and may be desirable for particular applications.

What is claimed is:

1. A charge air cooler, comprising:
inlet and outlet chambers adjacent one another and separated by a baffle defining a bypass passage for airflow therethrough;
heat exchange conduits connected between the inlet and outlet chambers; and
a valve disposed in the bypass passage and configured to selectively redirect at least a portion of the airflow therethrough responsive to a charge air cooler outlet temperature being below a condensation temperature of the airflow.

2. The charge air cooler of claim 1, wherein the condensation temperature is a dew point of the airflow determined from ambient air temperature and relative humidity.

3. The charge air cooler of claim 1, wherein the valve is further configured to close the bypass passage responsive to the charge air cooler outlet temperature exceeding the condensation temperature of the airflow.

4. The charge air cooler of claim 1, wherein the valve includes a valve flap movable to open and close the bypass passage, the valve flap having a turbulence-generating element arranged on an exterior surface thereof that is adapted to generate turbulence within the airflow in the charge air cooler.

5. The charge air cooler of claim 4, wherein the turbulence-generating element is one of dimples, ribs, embossings, and protrusions.

6. The charge air cooler of claim 4, wherein the valve flap further includes protrusions and recesses along a periphery thereof that are adapted to create turbulence within the airflow in the charge air cooler.

7. The charge air cooler of claim 1, further comprising:
a solenoid coupled to the valve; and
a pulse width modulator coupled to the solenoid and operable to selectively actuate the valve.

8. The charge air cooler of claim 1, further comprising:
a stepper motor coupled to the valve, the stepper motor actuatable to open and close the valve.

9. The charge air cooler of claim 1, wherein the valve is a magnetically actuated valve.

10. A charge air cooler, comprising:
an inlet chamber adjacent an outlet chamber;
heat exchange conduits connected between the inlet and outlet chambers;
a bypass fluidly connecting the inlet chamber to the outlet chamber; and
a flow control device positioned in the bypass and configured to control airflow from the inlet chamber to the outlet chamber through the bypass to maintain a charge air cooler outlet temperature above a condensation temperature of the airflow.

11. The charge air cooler of claim 10, wherein the flow control device is further configured to open the bypass responsive to the charge air cooler outlet temperature being below the condensation temperature of the airflow.

12. The charge air cooler of claim 10, wherein the flow control device is further configured to close the bypass responsive to a temperature difference between the inlet chamber and the outlet chamber being below a threshold.

13. The charge air cooler of claim 12, wherein the flow control device is further configured to open the bypass responsive to the temperature difference between the inlet chamber and the outlet chamber exceeding the threshold.

14. The charge air cooler of claim 10, wherein the flow control device is one of a solenoid valve, a stepper motor valve and a magnetically actuated valve.

15. The charge air cooler of claim 10, wherein the condensation temperature of the airflow is a dew point of the airflow determined from ambient air temperature and relative humidity.

16. A method for controlling airflow within a charge air cooler having a bypass fluidly connecting an inlet chamber to an outlet chamber, comprising:
in response to a charge air cooler outlet temperature being below a condensation temperature of the airflow, commanding a valve disposed within the bypass to open and redirect at least a portion of the airflow through the bypass.

17. The method of claim 16, further comprising:
commanding the valve to close the bypass in response to the charge air cooler outlet temperature exceeding the condensation temperature of the airflow.

18. The method of claim 16, further comprising:
commanding the valve to open the bypass in response to a temperature differential between the inlet and outlet chambers exceeding a corresponding threshold.

19. The method of claim 16, wherein the valve includes a valve plate movable to open and close the bypass, wherein the valve plate includes a turbulence-generating element adapted to create turbulence within the airflow in the charge air cooler.

20. The method of claim 16, wherein the valve is a proportional valve that adjusts a flow rate of air through the bypass based on the charge air cooler outlet temperature relative the condensation temperature of the airflow.
